(19) United States
(12) Patent Application Publication
(10) Pub. No.: US 2026/0043705 A1
(43) Pub. Date: Feb. 12, 2026

(54) WEIGHING MECHANISM FOR VERTICAL DYNAMIC BALANCING MACHINE

(71) Applicants: Shanghai Jianping Dynamic Balancing Machine Manufacturing Co., Ltd., Shanghai (CN); Jianping (Suzhou) Technology Co., Ltd., Suzhou (CN)

(72) Inventor: Guangbo CHENG, Shanghai (CN)

(73) Assignees: Shanghai Jianping Dynamic Balancing Machine Manufacturing Co., Ltd., Shanghai (CN); Jianping (Suzhou) Technology Co., Ltd., Suzhou (CN)

(21) Appl. No.: 19/363,686

(22) Filed: Oct. 21, 2025

Related U.S. Application Data
(63) Continuation of application No. PCT/CN2025/081288, filed on Mar. 7, 2025.

(30) Foreign Application Priority Data
Jul. 1, 2024 (CN) 202411036883.1

(51) Int. Cl. G01M 1/02

(52) U.S. Cl. CPC G01M 1/02

(57) ABSTRACT

A weighing mechanism for a vertical dynamic balancing machine includes a base, a support frame, a horizontal positioning plate, a mounting base and a support plate, where four sides of the mounting base are fixedly provided with adjusting blocks, the horizontal positioning plate is configured in a concentric-square-shaped structure, the mounting base is located on an inner side of the horizontal positioning plate, and the mounting base does not come into contact with the horizontal positioning plate; and the four adjusting blocks are all located below the horizontal positioning plate. Rapid weight measurement of a to-be-tested workpiece is achieved, thereby facilitating weight addition or removal operations on the workpiece. When dynamic balancing testing is continued after weighing, the mounting base can be lifted and adjusted to a horizontal state by cooperation of lifting assemblies with the adjusting blocks, such that a dynamic balancing mechanism can be kept horizontal.

### CROSS-REFERENCE TO THE RELATED APPLICATIONS

This application is a continuation application of International Application No. PCT/CN2025/081288, filed on Mar. 7, 2025, which is based upon and claims priority to Chinese Patent Application No. 202411036883.1, filed on Jul. 31, 2024, the entire contents of which are incorporated herein by reference.

### TECHNICAL FIELD

The present disclosure relates to the technical field of dynamic balancing machines, and in particular to a weighing mechanism for a vertical dynamic balancing machine.

### BACKGROUND

A balancing machine is a specialized apparatus for measuring a magnitude and a phase position of imbalance in a rotating object. During rotation, a centrifugal force is generated when a center of mass of a rotor does not coincide with an axis of rotation thereof. The centrifugal force resulting from such imbalance causes rotor bearings to undergo unnecessary vibrations, which not only increases noise but may also accelerate bearing wear, thereby significantly degrading the operational performance of the product and shortening the expected service life thereof. Therefore, it is critical to perform precise balancing correction of the product by using a balancing machine before the product leaves the factory.

Vertical dynamic balancing machines specifically refer to the balancing machines designed with vertically mounted drive spindles, and are widely used for balance testing of various components without integrated spindles. Such an apparatus is generally composed of a chassis, where a dynamic balancing mechanism is disposed in the chassis. A workpiece clamping portion is disposed at a top of the dynamic balancing mechanism and extends from a top of the chassis for fixing a to-be-tested workpiece. Subsequently, the dynamic balancing mechanism is activated to rotate the workpiece for dynamic balancing testing.

Prior to dynamic balancing testing on a rotor, weight measurement is typically performed to ensure the testing accuracy. During the dynamic balancing process, weight addition or removal operations are performed on the workpiece according to real-time data acquired to optimize the balance state. However, in production processes in the prior art, weighing and dynamic balancing testing are usually two independent steps performed on different apparatuses. This situation not only requires an operator to physically transfer the workpiece and switch operations between the two procedures to reduce the detection efficiency, but also increases operational complexity and potential error risks.

To improve the production efficiency and simplify the operational process, it is considered to integrate a weighing mechanism directly into the balancing machine to measure a total weight of the dynamic balancing mechanism and the to-be-tested workpiece, such that weight measurement and dynamic balancing testing are continuously completed on a single apparatus. However, this integration solution is subjected to two main technical challenges: first, since a weighing end of the weighing mechanism is typically telescopic, mounting the dynamic balancing mechanism above the weighing end may cause instability of the dynamic balancing mechanism, thereby affecting the accuracy and repeatability of the testing process; and second, vibrations generated by the dynamic balancing mechanism during testing may be transmitted to the weighing mechanism, which impairs the performance and service life of a weighing sensor.

Therefore, it is necessary to provide a weighing mechanism for a vertical dynamic balancing machine to solve the above technical problems.

### SUMMARY

An objective of the present disclosure is to provide a weighing mechanism for a vertical dynamic balancing machine, so as to achieve rapid weight measurement of a to-be-tested workpiece, which facilitates weight addition or removal operations on the workpiece, and also ensures the dynamic balancing detection precision.

The above technical objective of the present disclosure is implemented by the following technical solution: a weighing mechanism for a vertical dynamic balancing machine includes a base, a support frame, a horizontal positioning plate, a mounting base and a support plate, where four sides of the mounting base are fixedly provided with adjusting blocks, the horizontal positioning plate is configured in a concentric-square-shaped structure, the mounting base is located on an inner side of the horizontal positioning plate, and the mounting base does not come into contact with the horizontal positioning plate; the four adjusting blocks are all located below the horizontal positioning plate, the horizontal positioning plate is mounted on the support frame, a bottom end of the support frame is connected to the ground, a mounting seat is fixedly mounted at a top end of the base, a weighing sensor is mounted on the mounting seat, a weighing pan is fixedly mounted at a weighing end of the weighing sensor, a bottom end of the mounting base extends into the weighing pan, and a gap is retained between a peripheral wall of the mounting base and an inner wall of the weighing pan, such that when the mounting base is lifted upward, the mounting base does not come into contact with the weighing pan; and a support plate is fixedly mounted on the support frame, a plurality of lifting assemblies are disposed on the support plate, and the plurality of lifting assemblies are disposed correspondingly under the adjusting blocks.

A further configuration of the present disclosure is as follows: each of the lifting assemblies includes a first cylinder barrel, a first piston, a piston rod, and a pressure ring, where the first cylinder barrel is fixedly mounted at a top end of the support plate, the first piston is slidably mounted in the first cylinder barrel, a bottom end of the piston rod is fixedly connected to the first piston, the piston rod penetrates through a top wall of the first cylinder barrel, the pressure ring is fixedly sleeved on a top of the piston rod, and the top of the piston rod is configured in a frustum cone shape; a bottom of the adjusting block is provided with a recess, and the recess matches the top of the piston rod; and an oil supply assembly configured to deliver oil into the first cylinder barrel is disposed on the support plate.

A further configuration of the present disclosure is as follows: the oil supply assembly includes a second cylinder barrel, a second piston, a drive motor, and a screw rod, where the second cylinder barrel is fixedly mounted on the top end of the support plate, and the second piston slides up and down in the second cylinder barrel; the drive motor is fixedly mounted at a top end of the second cylinder barrel, the screw rod is fixedly mounted at an output end of the drive motor, the screw rod penetrates through the second piston, and the screw rod is threadedly connected to the second piston; first oil delivery pipes are communicatively disposed on both sides of a bottom of the second cylinder barrel, the second cylinder barrel is in communication with the two first cylinder barrels located on both sides of the second cylinder barrel through the two first oil delivery pipes, and the two first cylinder barrels on both sides of the second cylinder barrel are respectively in communication with two additional first cylinder barrels through second oil delivery pipes; and the first cylinder barrels, the second cylinder barrel, the first oil delivery pipes, and the second oil delivery pipes are filled with oil, and a valve assembly is disposed on each of the first oil delivery pipes and the second oil delivery pipes.

A further configuration of the present disclosure is as follows: each of the valve assemblies includes a valve casing, a valve ball, and a valve shaft, where the valve shaft is rotatably connected to the valve casing, the valve ball is rotatably mounted in the valve casing, and a communication hole is formed in the valve ball; the plurality of valve assemblies are disposed along a straight line, the valve shafts penetrate through the support plate, a gear is fixedly mounted at a bottom end of each of the plurality of valve shafts, a linear actuator is fixedly mounted at a bottom end of the support plate, an output end of the linear actuator is fixedly connected to a rack, and the rack meshes simultaneously with the plurality of gears.

A further configuration of the present disclosure is as follows: a hydraulic pressure sensor is mounted on the second cylinder barrel, and the hydraulic pressure sensor is electrically connected to the linear actuator through a programmable logic controller (PLC).

A further configuration of the present disclosure is as follows: a first conducting plate is embedded at a top end of the piston rod, a bottom end of the first conducting plate is connected to a wire, and the wire is electrically connected to a power supply; a second conducting plate is fixedly mounted in the recess at a bottom of each of the adjusting blocks, a connecting interface is disposed on a side of the mounting base, and the connecting interface is electrically connected to the second conducting plate; and when the top end of the piston rod is inserted into the recess, the first conducting plate comes into contact with the second conducting plate.

A further configuration of the present disclosure is as follows: a gas delivery passage is formed in the piston rod, a top opening of the gas delivery passage is located at the top end of the piston rod, and a bottom opening of the gas delivery passage is located on a side of the bottom of the piston rod.

A further configuration of the present disclosure is as follows: a filter net is mounted at a top end of the gas delivery passage.

A further configuration of the present disclosure is as follows: adjusting feet are mounted at four corners of the bottom end of the support frame.

A further configuration of the present disclosure is as follows: a level gauge is disposed on the horizontal positioning plate.

In summary, the present disclosure has the following beneficial effects: According to the present disclosure, rapid weight measurement of a to-be-tested workpiece is achieved, thereby facilitating weight addition or removal operations on the workpiece. When dynamic balancing testing is continued after weighing, the mounting base can be lifted and adjusted to a horizontal state by cooperation of the lifting assemblies with the adjusting blocks, such that a dynamic balancing mechanism on the mounting base can be kept horizontal to ensure the dynamic balancing detection precision. Moreover, the adjusting blocks can be fixed through the pressure rings and the horizontal positioning plate, such that the mounting base is kept stable. After being lifted, the mounting base separates from the weighing pan, such that vibrations generated by the dynamic balancing mechanism during testing of the to-be-tested workpiece are not transmitted to the weighing sensor under the weighing pan, thereby effectively extending the service life of the weighing sensor. The support frame and the support plate support the lifting assemblies, the mounting base, and the dynamic balancing mechanism, such that vibrations generated during testing are not transmitted to the chassis, and electronic components in the chassis are not affected by the vibrations, thereby prolonging the service life of the electronic components in the chassis. Additionally, through unique arrangement of the lifting assemblies, even if the chassis is not placed horizontally, the mounting base and the dynamic balancing mechanism mounted thereon can be automatically adjusted to a horizontal state after the mounting base is lifted by the lifting assemblies, thereby ensuring the measurement precision, avoiding reduced levelness of the chassis arising from vibrations generated by the dynamic balancing mechanism during prolonged measurement, and improving the detection precision of the apparatus.

### BRIEF DESCRIPTION OF THE DRAWINGS

FIG. 1 is a schematic three-dimensional structural view of the present disclosure.

FIG. 2 is a schematic enlarged structural view of a portion A in FIG. 1.

FIG. 3 is a schematic structural view of a mounting base, a base, and a mounting seat of the present disclosure.

FIG. 4 is a schematic structural view of a support frame, a support plate, and a horizontal positioning plate of the present disclosure.

FIG. 5 is a schematic structural view of a lifting assembly, an oil supply assembly, and a valve assembly of the present disclosure.

FIG. 6 is a schematic sectional structural view of a lifting assembly of the present disclosure.

FIG. 7 is a schematic enlarged structural view of a portion B in FIG. 6.

FIG. 8 is a schematic sectional structural view of an oil supply assembly of the present disclosure.

FIG. 9 is a schematic sectional structural view of a valve assembly of the present disclosure.

FIG. 10 is a schematic sectional structural view of an adjusting block of the present disclosure.

In the figures: 1—base; 2—mounting seat; 3—weighing sensor; 4—weighing pan; 5—mounting base; 6—adjusting block; 7—lifting assembly; 71—first cylinder barrel; 72—first piston; 73—piston rod; 7301—gas delivery passage; 74—pressure ring; 8—oil supply assembly; 81—second cylinder barrel; 82—second piston; 83—drive motor; 84—screw rod; 9—support frame; 10—horizontal positioning plate; 11—level gauge; 12—adjusting foot; 13—support plate; 14—chassis; 15—filter net; 16—first conducting plate; 17—wire; 18—second conducting plate; 19—first oil delivery pipe; 20—second oil delivery pipe; 21—valve casing; 22—valve shaft; 23—gear; 24—valve ball; 25—rack; 26—linear actuator; 27—hydraulic pressure sensor; and 28—connecting interface.

### DETAILED DESCRIPTION OF THE EMBODIMENTS

The present disclosure will be further explained below in combination with drawings in embodiments of the present disclosure.

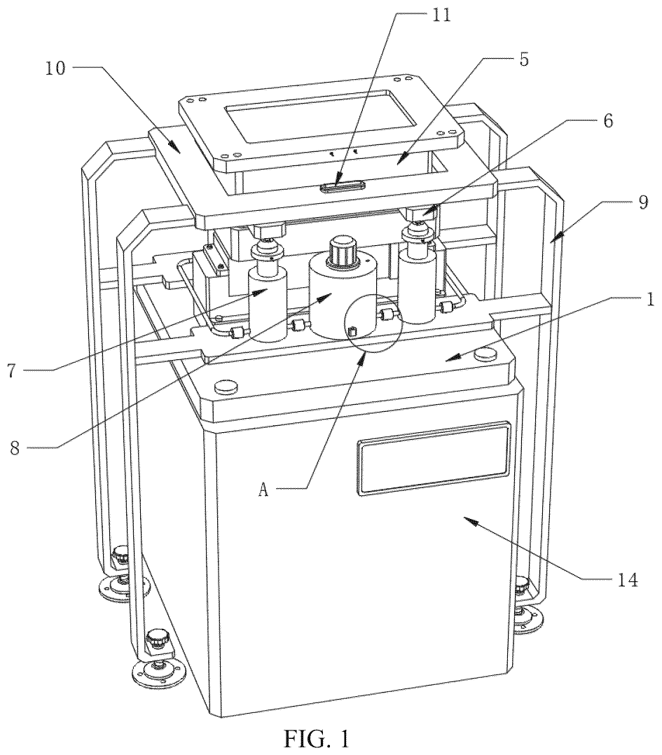

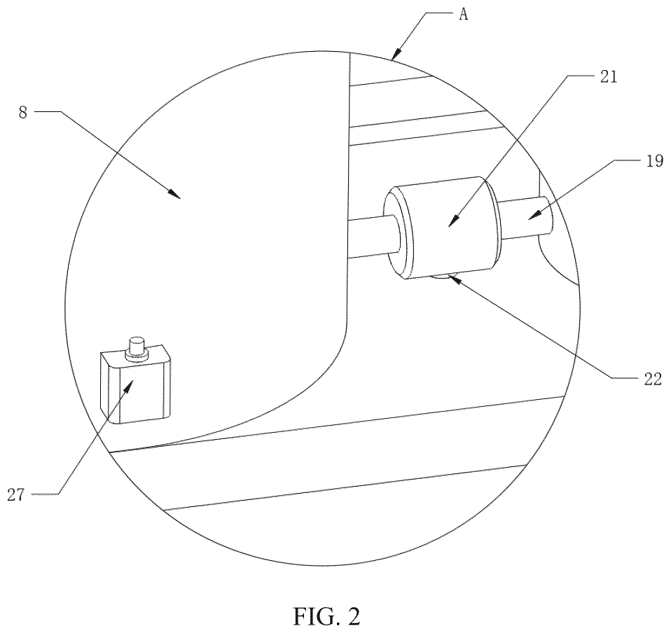

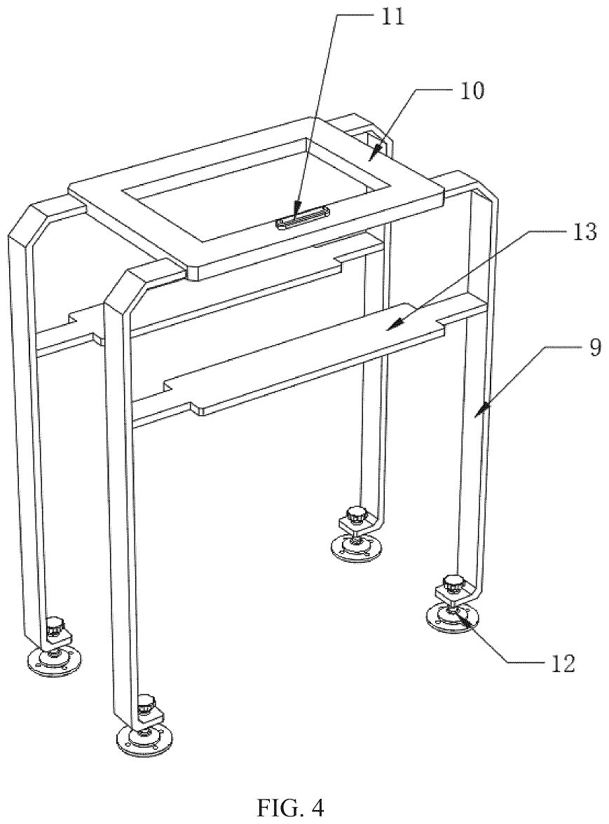

With reference to FIGS. 1-4, in an embodiment of the present disclosure, a weighing mechanism for a vertical dynamic balancing machine includes a base 1, a support frame 9, a horizontal positioning plate 10, a mounting base 5 and support plates 13, where the base 1 is mounted at a top end of a chassis 14 of a dynamic balancing machine, the mounting base 5 is configured to mount a dynamic balancing mechanism of the dynamic balancing machine, a clamping mechanism is disposed on the dynamic balancing mechanism to clamp a to-be-tested workpiece, and a motor is disposed on the dynamic balancing mechanism to drive the clamping mechanism to rotate, thereby driving the to-be-tested workpiece to rotate; four sides of the mounting base 5 are fixedly provided with adjusting blocks 6, the horizontal positioning plate 10 is configured in a concentric-square-shaped structure, the mounting base 5 is located on an inner side of the horizontal positioning plate 10, and the mounting base 5 does not come into contact with the horizontal positioning plate 10; the four adjusting blocks 6 are all located below the horizontal positioning plate 10, the horizontal positioning plate 10 is mounted on the support frame 9, a bottom end of the support frame 9 is connected to the ground, a mounting seat 2 is fixedly mounted at a top end of the base 1, a weighing sensor 3 is mounted on the mounting seat 2, a weighing pan 4 is fixedly mounted at a weighing end of the weighing sensor 3, a bottom end of the mounting base 5 extends into the weighing pan 4, and a gap is retained between a peripheral wall of the mounting base 5 and an inner wall of the weighing pan 4, such that when the mounting base 5 is lifted upward, the mounting base 5 does not come into contact with the weighing pan 4, thereby ensuring that the weighing sensor 3 is not affected during testing; and two support plates 13 are fixedly mounted on the support frame 9, the two support plates 13 are respectively located on both sides of the mounting seat 2, a plurality of lifting assemblies 7 are disposed on the two support plates 13, and the plurality of lifting assemblies 7 are disposed correspondingly under the adjusting blocks 6.

With reference to FIG. 1, when a total weight of the weighing pan 4, the dynamic balancing mechanism, and the to-be-tested workpiece is measured, output ends of the lifting assemblies 7 are in a retracted state; and at the moment, the output ends of the lifting assemblies 7 do not come into contact with the adjusting blocks 6, and a bottom wall of the mounting base 5 comes into contact with the weighing pan 4. A weight measured by the weighing sensor 3 at the moment is the total weight of the dynamic balancing mechanism, the to-be-tested workpiece, and the weighing pan 4, and the weight of the to-be-tested workpiece is obtained by subtracting the weight of the dynamic balancing mechanism and the weighing pan 4 from the total weight, thereby achieving weight measurement of the to-be-tested workpiece, and facilitating weight addition or removal operations on the workpiece. When dynamic balancing testing is continued after weighing, the output ends of the lifting assemblies 7 are controlled to extend, the output ends of the lifting assemblies 7 come into contact with the adjusting blocks 6 and push the mounting base 5 to move upward, and top walls of the four adjusting blocks 6 come into contact with a bottom wall of the horizontal positioning plate 10, such that the four adjusting blocks 6 remain in a horizontal state, the mounting base 5 also stays in a horizontal state, the dynamic balancing mechanism on the mounting base 5 is kept horizontal to ensure the dynamic balancing detection precision. Moreover, the adjusting blocks 6 can be fixed through pressure rings 74 and the horizontal positioning plate 10, such that the mounting base 5 is kept stable. After being lifted, the mounting base 5 separates from the weighing pan 4, such that vibrations generated by the dynamic balancing mechanism during testing of the to-be-tested workpiece are not transmitted to the weighing sensor 3 under the weighing pan 4, thereby effectively extending the service life of the weighing sensor. The support frame 9 and the support plates 13 support the lifting assemblies 7, the mounting base 5, and the dynamic balancing mechanism, such that vibrations generated during testing are not transmitted to the chassis 14, and electronic components in the chassis 14 are not affected by the vibrations, thereby prolonging the service life of the electronic components in the chassis 14.

In this embodiment, preferably, adjusting feet 12 are mounted at four corners of the bottom end of the support frame 9, and the adjusting feet 12 are adjustable in height, thereby achieving levelness adjustment of the concentric-square-shaped plate. Bottom ends of the adjusting feet 12 are fixedly connected to the ground through connecting structures such as bolts or suction cups, thereby achieving levelness adjustment of the concentric-square-shaped plate.

In this embodiment, preferably, a level gauge 11 is mounted on the horizontal positioning plate 10. By observing the level gauge 11, whether the horizontal positioning plate 10 is in a horizontal state can be determined, thereby facilitating levelness adjustment of the horizontal positioning plate 10 through the adjusting feet 12.

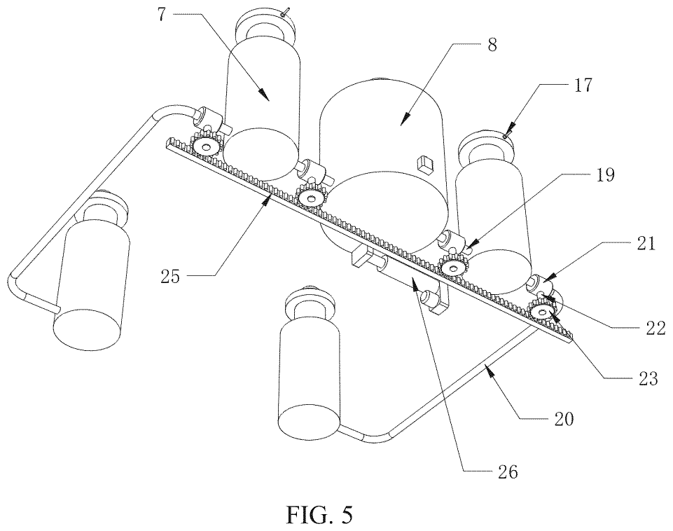

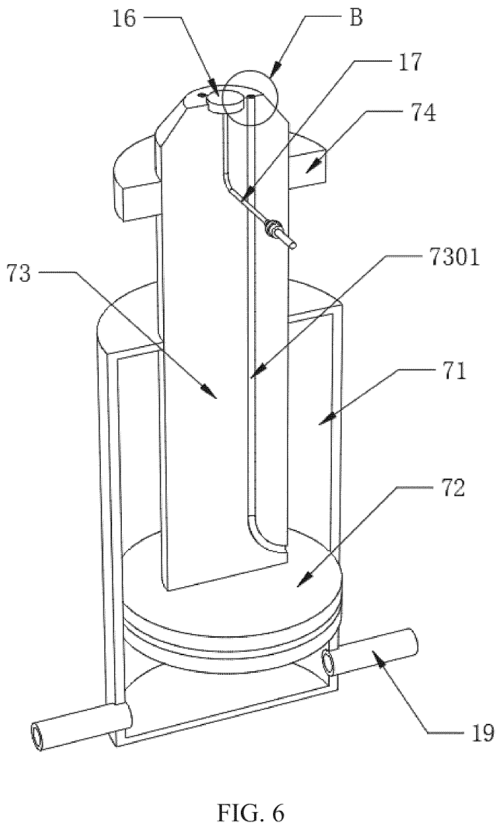

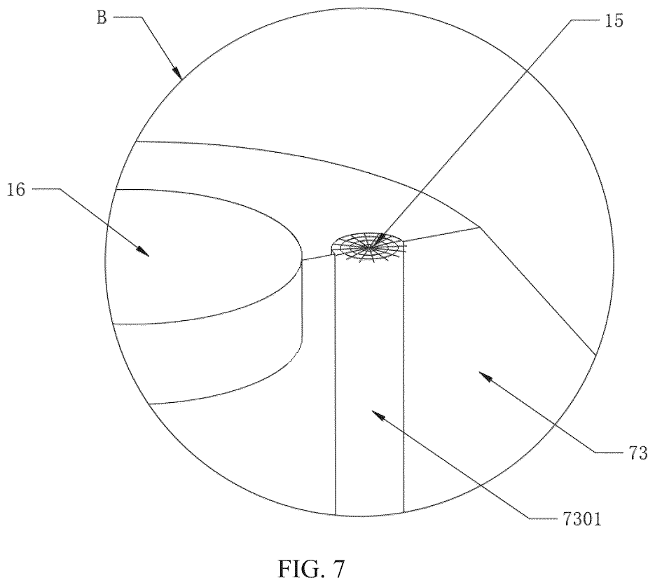

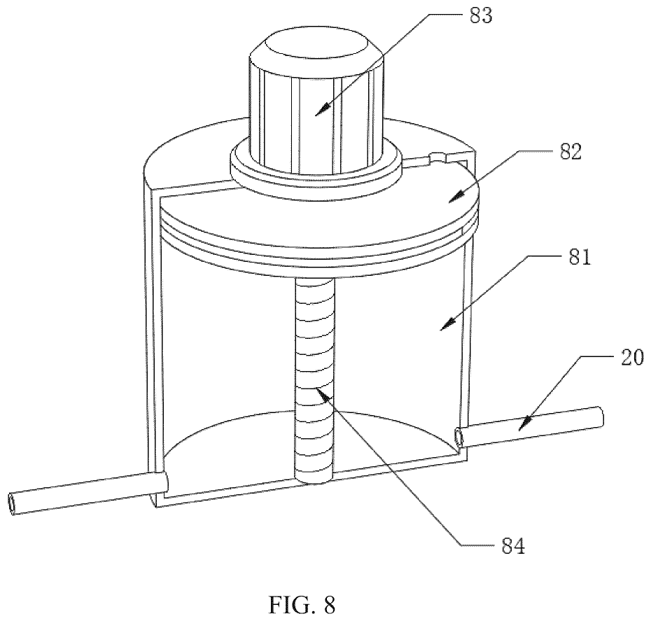

With reference to FIGS. 5-8, in this embodiment, each of the lifting assemblies 7 includes a first cylinder barrel 71, a first piston 72, a piston rod 73, and a pressure ring 74, where the first cylinder barrel 71 is fixedly mounted at a top end of the support plate 13, the first piston 72 is slidably mounted in the first cylinder barrel 71, a bottom end of the piston rod 73 is fixedly connected to the first piston 72, the piston rod 73 penetrates through a top wall of the first cylinder barrel 71, the pressure ring 74 is fixedly sleeved on a top of the piston rod 73, and the top of the piston rod 73 is configured in a frustum cone shape; a bottom of the adjusting block 6 is provided with a recess, and the recess matches the top of the piston rod 73, such that when the top of the piston rod 73 is inserted into the recess, an outer peripheral wall of the piston rod 73 is closely fit with an inner peripheral wall of the recess; and an oil supply assembly 8 configured to deliver oil into the first cylinder barrel 71 is disposed on the support plate 13.

Further, the oil supply assembly 8 includes a second cylinder barrel 81, a second piston 82, a drive motor 83, and a screw rod 84, where the second cylinder barrel 81 is fixedly mounted on the top end of the support plate 13, the second piston 82 slides up and down in the second cylinder barrel 81, and the second piston 82 can only slide up and down relative to the second cylinder barrel 81 and cannot rotate relative to the second cylinder barrel 81; the drive motor 83 is fixedly mounted at a top end of the second cylinder barrel 81, the screw rod 84 is fixedly mounted at an output end of the drive motor 83, the screw rod 84 penetrates through the second piston 82, and the screw rod 84 is threadedly connected to the second piston 82; first oil delivery pipes 19 are communicatively disposed on both sides of a bottom of the second cylinder barrel 81, the second cylinder barrel 81 is in communication with the two first cylinder barrels 71 located on both sides of the second cylinder barrel 81 through the two first oil delivery pipes 19, and the two first cylinder barrels 71 on both sides of the second cylinder barrel 81 are respectively in communication with two additional first cylinder barrels 71 through second oil delivery pipes 20; and the first cylinder barrels 71, the second cylinder barrel 81, the first oil delivery pipes 19, and the second oil delivery pipes 20 are filled with oil, and a valve assembly is disposed on each of the first oil delivery pipes 19 and the second oil delivery pipes 20.

When it is necessary to lift the mounting base 5, the drive motor 83 is activated to drive the screw rod 84 to rotate. As the screw rod 84 rotates, the second piston 82 is driven to move downward. As the second piston 82 moves, oil in the second cylinder barrel 81 is delivered into the first cylinder barrels 71 through the first oil delivery pipes 19 and the second oil delivery pipes 20, such that the first pistons 72 in the first cylinder barrels 71 are driven to move upward. As the first pistons 72 move upward, the piston rods 73 are driven to move upward, such that top ends of the piston rods 73 extend into the corresponding recesses in the bottoms of the adjusting blocks 6, the adjusting blocks 6 are pushed to move upward, and top walls of the four adjusting blocks 6 come into contact with a bottom wall of the horizontal positioning plate 10. Consequently, the four adjusting blocks 6 remain in a horizontal state, and the mounting base 5 also stays in a horizontal state. At the moment, the pressure rings 74 press against bottom walls of the adjusting blocks 6, thereby squeezing and fixing the adjusting blocks 6. Through unique arrangement of the lifting assemblies, even if the chassis 14 is not placed horizontally, the mounting base 5 and the dynamic balancing mechanism mounted thereon can be automatically adjusted to a horizontal state after the mounting base 5 is lifted by the lifting assemblies, thereby ensuring the measurement accuracy, avoiding reduced levelness of the chassis 14 arising from vibrations generated by the dynamic balancing mechanism during prolonged measurement, and improving the detection precision of the apparatus.

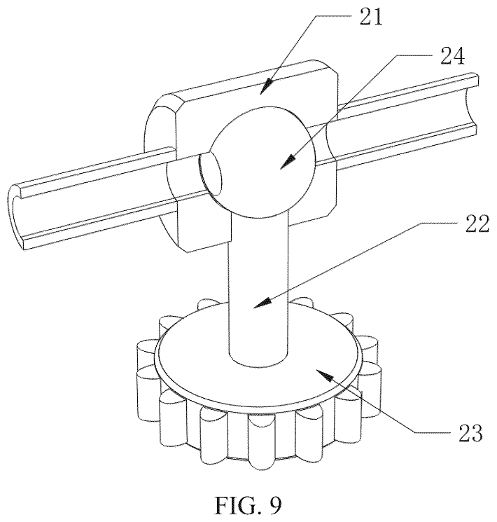

With reference to FIGS. 5 and 9, in this embodiment, preferably, each of the valve assemblies includes a valve casing 21, a valve ball 24, and a valve shaft 22, where the valve shaft 22 is rotatably connected to the valve casing 21, the valve ball 24 is rotatably mounted in the valve casing 21, and a communication hole is formed in the valve ball 24. When the communication holes are in a horizontal state, the first oil delivery pipes 19 and the second oil delivery pipes 20 are in an open state; and when the communication holes in a vertical state, the first oil delivery pipes 19 and the second oil delivery pipes 20 are in a closed state. The plurality of valve assemblies are disposed along a straight line, the valve shafts 22 penetrate through the support plate 13, a gear 23 is fixedly mounted at a bottom end of each of the plurality of valve shafts 22, a linear actuator 26 is fixedly mounted at a bottom end of the support plate 13, an output end of the linear actuator 26 is fixedly connected to a rack 25, and the rack 25 meshes simultaneously with the plurality of gears 23. Extension and retraction of the output end of the linear actuator 26 drive the rack 25 to move. As the rack 25 moves, the gears 23 are driven to rotate, such that the valve balls 24 are driven to rotate through the valve shafts 22, thereby controlling the opening and closing states of the valve assemblies.

In this embodiment, preferably, a hydraulic pressure sensor 27 is mounted on the second cylinder barrel 81, and the hydraulic pressure sensor 27 is electrically connected to the linear actuator 26 through a PLC. When all top ends of the plurality of piston rods 73 are pressed against the adjusting blocks 6 and the adjusting blocks 6 are pressed against the horizontal positioning plate 10, an oil pressure in the second cylinder barrel 81 gradually increases as the second piston 82 continues moving downward. When the hydraulic pressure sensor 27 detects that the oil pressure in the second cylinder barrel 81 is relatively high, the PLC controls the output end of the linear actuator 26 to extend, and the rack 25 drives the gears 23 to rotate, such that the valve balls 24 rotate to block both the first oil delivery pipes 19 and the second oil delivery pipes 20. Consequently, the plurality of first cylinder barrels 71 are in a closed state, and the piston rods 73 cannot move upward, thereby ensuring the stability of the mounting base 5.

Because the dynamic balancing mechanism includes a motor, the motor is powered through a wire 17, and the wire 17 is connected to a power supply. During the weighing process of the dynamic balancing mechanism and the to-be-tested workpiece, the wire 17 connected to the power supply may affect the weighing accuracy. To solve this problem, the following embodiment is provided.

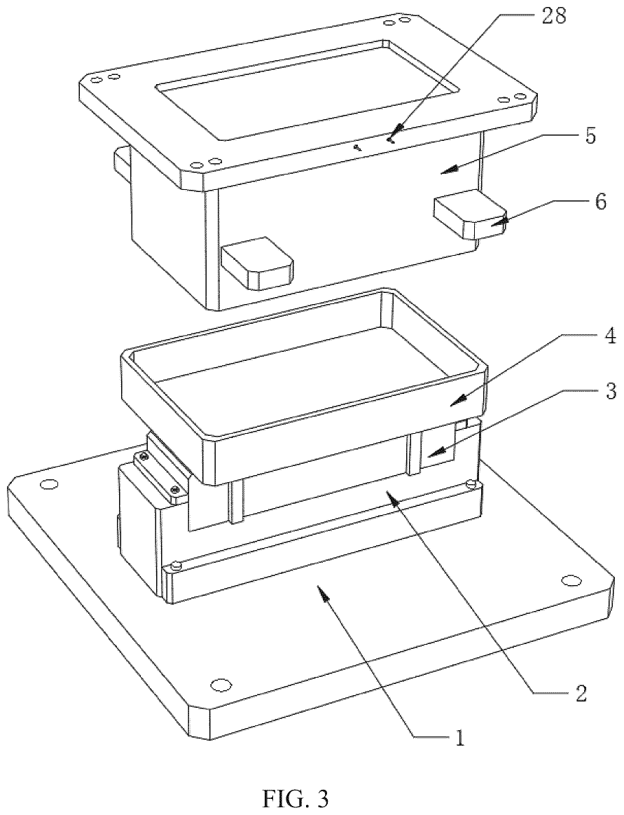

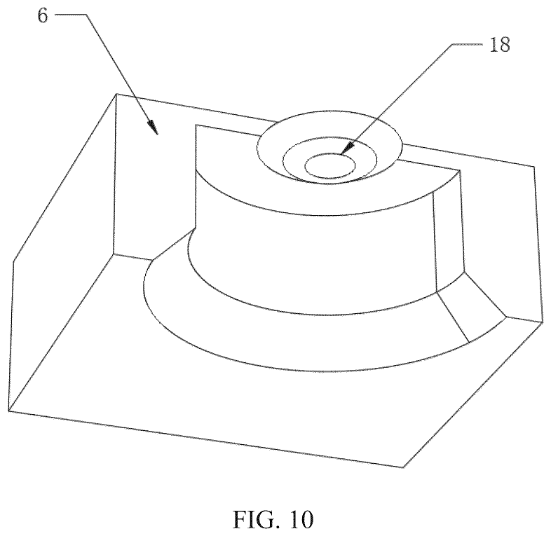

With reference to FIGS. 3, 6 and 10, in this embodiment, a first conducting plate 16 is embedded at a top end of the piston rod 73, a bottom end of the first conducting plate 16 is connected to the wire 17, and the wire 17 is electrically connected to a power supply; a second conducting plate 18 is fixedly mounted in the recess at a bottom of each of the adjusting blocks 6, a connecting interface 28 is disposed on a side of the mounting base 5, and the connecting interface 28 is electrically connected to the second conducting plate 18; and when the top end of the piston rod 73 is inserted into the recess, the first conducting plate 16 comes into contact with the second conducting plate 18, and the motor on the dynamic balancing mechanism is electrically connected to the second conducting plate 18. At the moment, power is supplied to the motor through the wire 17, the first conductive plate 16, the second conductive plate 18, and the connecting interface 28. During the weighing process, the piston rods 73 are separated from the adjusting blocks 6, and the first conducting plates 16 are separated from the second conducting plates 18, such that weighing of the dynamic balancing mechanism and the to-be-tested workpiece by the weighing sensor is no longer affected by the power-supplying wire 17, thereby improving the weighing accuracy.

In this embodiment, preferably, a gas delivery passage 7301 is formed in the piston rod 73, a top opening of the gas delivery passage 7301 is located at the top end of the piston rod 73, and a bottom opening of the gas delivery passage 7301 is located on a side of the bottom of the piston rod 73. When the piston rod 73 moves upward, gas above the first piston 72 is discharged through the gas delivery passage 7301, and the top opening of the gas delivery passage 7301 is disposed toward the recess, such that the discharged gas can act upon the second conducting plate 18. On one hand, the discharged gas is capable of cleaning the second conducting plate 18, and reducing dust accumulation on the second conducting plate 18; and on the other hand, the discharged gas is capable of cooling the second conducting plate 18, and preventing the second conducting plate 18 from overheating.

In this embodiment, preferably, a filter net 15 is mounted at a top end of the gas delivery passage 7301 to prevent impurities such as dust from entering the first cylinder barrel 71.

The above descriptions are only preferred embodiments of the present disclosure, and equivalent variations or modifications made to the structure, features, and principles within the scope of the patent application of the present disclosure should fall within the protection scope of the present disclosure.

What is claimed is:

1. A weighing mechanism for a vertical dynamic balancing machine, comprising a base, a support frame, a horizontal positioning plate, a mounting base and a support plate, wherein four sides of the mounting base are fixedly provided with four adjusting blocks, the horizontal positioning plate is configured in a concentric-square-shaped structure, the mounting base is located on an inner side of the horizontal positioning plate, and the mounting base does not come into contact with the horizontal positioning plate;
the four adjusting blocks are all located below the horizontal positioning plate, the horizontal positioning plate is mounted on the support frame, a bottom end of the support frame is connected to ground, a mounting seat is fixedly mounted at a top end of the base, a weighing sensor is mounted on the mounting seat, a weighing pan is fixedly mounted at a weighing end of the weighing sensor, a bottom end of the mounting base extends into the weighing pan, and a gap is retained between a peripheral wall of the mounting base and an inner wall of the weighing pan, wherein when the mounting base is lifted upward, the mounting base does not come into contact with the weighing pan; and
a support plate is fixedly mounted on the support frame, a plurality of lifting assemblies are disposed on the support plate, and the plurality of lifting assemblies are disposed correspondingly under the four adjusting blocks.

2. The weighing mechanism for the vertical dynamic balancing machine according to claim 1, wherein each of the plurality of lifting assemblies comprises a first cylinder barrel, a first piston, a piston rod, and a pressure ring, wherein the first cylinder barrel is fixedly mounted at a top end of the support plate, the first piston is slidably mounted in the first cylinder barrel, a bottom end of the piston rod is fixedly connected to the first piston, the piston rod penetrates through a top wall of the first cylinder barrel, the pressure ring is fixedly sleeved on a top of the piston rod, and the top of the piston rod is configured in a frustum cone shape;
a bottom of the adjusting block is provided with a recess, and the recess matches the top of the piston rod; and
the support plate is provided with an oil supply assembly configured to deliver oil into the first cylinder barrel.

3. The weighing mechanism for the vertical dynamic balancing machine according to claim 2, wherein the oil supply assembly comprises a second cylinder barrel, a second piston, a drive motor, and a screw rod, wherein the second cylinder barrel is fixedly mounted on the top end of the support plate, the second piston slides up and down in the second cylinder barrel;
the drive motor is fixedly mounted at a top end of the second cylinder barrel;
the screw rod is fixedly mounted at an output end of the drive motor, the screw rod penetrates through the second piston, and the screw rod is threadedly connected to the second piston;
two first oil delivery pipes are communicatively disposed on both sides of a bottom of the second cylinder barrel, the second cylinder barrel is in communication with two first cylinder barrels located on both sides of the second cylinder barrel through the two first oil delivery pipes, and the two first cylinder barrels on both sides of the second cylinder barrel are in communication with two additional first cylinder barrels through second oil delivery pipes; and
the first cylinder barrels, the second cylinder barrel, the two first oil delivery pipes, and the second oil delivery pipes are filled with oil, and a valve assembly is disposed on each of the two first oil delivery pipes and the second oil delivery pipes.

4. The weighing mechanism for the vertical dynamic balancing machine according to claim 3, wherein each of the valve assemblies comprises a valve casing, a valve ball, and a valve shaft, wherein the valve shaft is rotatably connected to the valve casing, the valve ball is rotatably mounted in the valve casing, and a communication hole is formed in the valve ball; and
the valve assemblies are disposed along a straight line, the valve shafts penetrate through the support plate, a gear is fixedly mounted at a bottom end of each of the valve shafts, a linear actuator is fixedly mounted at a bottom end of the support plate, an output end of the linear actuator is fixedly connected to a rack, and the rack meshes simultaneously with the gears.

5. The weighing mechanism for the vertical dynamic balancing machine according to claim 4, wherein a hydraulic pressure sensor is mounted on the second cylinder barrel, and the hydraulic pressure sensor is electrically connected to the linear actuator through a programmable logic controller (PLC).

6. The weighing mechanism for the vertical dynamic balancing machine according to claim 2, wherein a first conducting plate is embedded at a top end of the piston rod, a bottom end of the first conducting plate is connected to a wire, and the wire is electrically connected to a power supply;
a second conducting plate is fixedly mounted in the recess at a bottom of each of the four adjusting blocks, a connecting interface is disposed on a side of the mounting base, and the connecting interface is electrically connected to the second conducting plate; and
when the top end of the piston rod is inserted into the recess, the first conducting plate comes into contact with the second conducting plate.

7. The weighing mechanism for the vertical dynamic balancing machine according to claim 6, wherein a gas delivery passage is formed in the piston rod, a top opening of the gas delivery passage is located at the top end of the piston rod, and a bottom opening of the gas delivery passage is located on a side of the bottom of the piston rod.

8. The weighing mechanism for the vertical dynamic balancing machine according to claim 7, wherein a filter net is mounted at a top end of the gas delivery passage.

9. The weighing mechanism for the vertical dynamic balancing machine according to claim 1, wherein adjusting feet are mounted at four corners of the bottom end of the support frame.

10. The weighing mechanism for the vertical dynamic balancing machine according to claim 1, wherein a level gauge is mounted on the horizontal positioning plate.
